(19) United States
(12) Patent Application Publication
(10) Pub. No.: US 2017/0363276 A1
(43) Pub. Date: Dec. 21, 2017

(54) LED Light Has Optics Design

(71) Applicant: Tseng-Lu Chien, Walnut, CA (US)

(72) Inventor: Tseng-Lu Chien, Walnut, CA (US)

(21) Appl. No.: 15/472,698

(22) Filed: Mar. 29, 2017

Related U.S. Application Data
(63) Continuation-in-part of application No. 12/938,628, filed on Nov. 3, 2010.
Application No. 12/938,628 is a continuation-in-part of application No. 15/458,498, filed on Mar. 14, 2017.
Application No. 15/458,498 is a continuation-in-part of application No. 13/367,687, filed on Feb. 7, 2012, now Pat. No. 9,625,134.
Application No. 13/367,687 is a continuation-in-part of application No. 13/162,824, filed on Jun. 17, 2011, now Pat. No. 8,950,899.
Application No. 13/162,824 is a continuation-in-part of application No. 12/894,865, filed on Sep. 30, 2010, now Pat. No. 8,393,755.
Application No. 12/894,865 is a continuation-in-part of application No. 12/887,709, filed on Sep. 22, 2010, now abandoned.
Application No. 15/458,498 is a continuation-in-part of application No. 13/367,816, filed on Feb. 7, 2012, now Pat. No. 8,944,669.

(51) Int. Cl. F21V 21/096; F21V 15/01; F21V 5/04; F21S 9/02; F21V 7/00; F21V 23/04; F21V 19/00

(52) U.S. Cl. CPC F21V 21/096; F21V 23/0471; F21V 15/01; F21V 19/0015; F21S 9/02; F21V 7/00; F21V 5/04; F21V 23/04

(57) ABSTRACT

The current invention applying super slim LED-unit(s) has built-in contactors has (a) magnetic only or (b) conductive magnetic-movable-kits so can attach or detachable metal magnetic-field reactive buss-strips. The conductive-movable type which also can deliver electric current from buss-strips of track light. The super slim LED light or units is a DC powered LED light has optics design become super thin and none bright-spots. The said LED-units install under the light-block material housing or parts, and light-beam go through at least of reflective surface at inner surface or walls. The said LED-unit install on hard or bendable circuit board with divider the compartment only has LED, lit-lens, reflective housing. The compartment is only space where light-beam traveling and has multiple times reflected and emit out from top lens. The said light beam emit out from LED-unit(s) reflected by high reflective surface or wall including (1) white high-polished plastic or (2) metalized mirror-like or (3) shining metal piece back-and-forth and light emit out from top lens. The current invention has multiple time reflective and refractive optic theory to make the super thin light for SMD LED(s) on hard or bendable PCB to get in-direct light beam. To get none bright-sports by not install LED(s) under face top lens. The Track LED light or LED-unit has slim features with different size can use as ceiling, closet, kitchen, laundry, door, garage, patio or anywhere for building, residence, house for indoor or outdoor use.

This invention all drawing is use the PARENT Filed drawings. So, the current invention is CIP filing for

(#UU) Ser. No. 12/938,628 (Nov. 3, 2010 F) (Public US 2012-010-6202) May 3, 2012=Has (#RR-10Drawing)&(T→change to I=Bendable vs Qirky).
The public No. US 2012/0106-6202 as below attachment drawing.
LED light fixture has outlet(s) and removable LED unit(s) and for

The current invention also CIP for (#LLL-1) Ser. No. 15,458,498 Filed on Mar. 14, 2017 which is CIP filing for (#LLL-2011) Ser. No. 13,367,687 now pay issue fee. Also, the current invention is Division filing for below listed filing case U.S. Pat. No. 8,950,899 (#HHH-2011)=→Ser. No. 13,162,824 filed on Jun. 17, 2011

U.S. Pat. No. 8,944,669 (#NNN)=====→Ser. No. 13,367,816 Filed on Feb. 7, 2012
U.S. Pat. No. 8,393,755 (# T-1)=====→Ser. No. 12,894,865 Filed on Sep. 30, 2010
U.S. Pat. No. 8,083,392 (#RR-10)==→Ser. No. 12,887,709 Filed on Sep. 22, 2010

The current invention apply Parent filed case drawing and construction same. It is appreciated current invention with some alternative or replaceable or equal function as below listed filed drawing and concept and construction for LED track light.

The current invention also All these are Continuously filing for

(#JJJ) Ser. No. 13/296,508, filed on Nov. 15, 2011, Now U.S. Pat. No. 8,562,158
(#KKK) Ser. No. 13/295,301, filed Nov. 15, 2011 Now U.S. Pat. No. 8,760,514
(#III) Ser. No. 13/296,469, filed on Nov. 15, 2011, Now U.S. Pat. No. 8,711,216 are continuously filing for
(#HHH-11) Ser. No. 13/162,824 filed Jun. 17, 2011 Now U.S. Pat. No. 8,950,899 Light device with display means has track-means and removable LED-unit(s) which are the continuously filing for
(#UU) Ser. No. 12/938,628 (Nov. 3, 2010 F) (Public US 2012-010-6202) May 3, 2012=Has (#RR-10Drawing)&(T→change to I=Bendable vs Qirky). The public No. US 2012/0106-6202 as above attachments drawing
LED track light has added-on ad detachable LED unit(s)
(#RR-2010) Ser. No. 12/887,709 Filed on Sep. 22, 2010 now is U.S. Pat. No. 8,083,392 Light fixture with self-power removable LED unit(s). Those are continuously filing for
(#Z-08) Ser. No. 12/149,963 filed May 12, 2008 Now is U.S. Pat. No. 7,901,115 (Now U.S. Pat. No. 7,722,230),
(#Y-08) Ser. No. 12/073,095 filed Feb. 29, 2008 (Now U.S. Pat. No. 7,726,869),
(#X) Ser. No. 12/073,889 now U.S. Pat. No. 8,827,511 (Co-Pending Filing),
(#W-08) Ser. No. 12/007,076 filed on Jan. 7, 2008 (Now U.S. Pat. No. 7,726,841),
(#V-08) Ser. No. 12/003,691 Filed Dec. 31, 2007 (Now U.S. Pat. No. 7,726,839),
(#T-1) Ser. No. 12/894,865 Filed on Sep. 30, 2010 (Now U.S. Pat. No. 8,393,755).

### BACKGROUND

The current invention design for LED Florescent tube or other LED light source which The Device has LED Track with movable, attachable, detachable

From market place all the said LED Florescent tube of other LED light source which normally has special design such as Philips or Osram or Feith with their complicated construction in order to get wide view angle of light and high brightness. But each of them has very complicated construction and costly for their design. The current invention incorporated unique movable, attachable, detachable LED-units along the track can easily to get the

(1) Add or Reduce movable and detachable LED-units anywhere along the length or from ends
(2) Only need to make several different numbers of track or buss-strips can make variety different brightness, size, diameter, length, viewing angle, shape to get full range really florescent tube or other under-cabinet or closet light function to let consumer replace without any mistake
(3) Offer sufficient working illumination as head-width and get the LED illumination as people's shoulder width to save non-working area(s) illumination which means save a lot of power consumption of non-working area(s) LED light cost and energy saving
(4) Come out the most economical LED light source to let consumer willing to replace the really or full LED Florescent tube to super power saving LED light source to save power consumption, save money, save energy and save earth.

The most important the current invention can make any requirement for brightness, illumination areas, color of light, size of illumination area(s) and can be adjustable the above details by consumer itself in seconds.

It is appreciated the current invention has all above discussed co-pending or issued patent's drawing, details description and content are still been the parent filing of the current invention and all such drawing, detail description, contents should be still fall within the scope of the current invention claims and not limited to the current drawing, details description, content.

### DRAWING

First 3 pages is co-pending (#UU) Ser. No. 12/938,628 (Nov. 3, 2010 F) (Public US 2012-010-6202) May 3, 2012=Has (#RR-10Drawing)&(T→change to I=Bendable vs Qirky). The public No. US 2012/0106-6202 drawing for LED track light has added-on ad detachable LED unit(s)

And the same drawing show on the Child Filed case;

(#RR-2010) Ser. No. 12/887,709 Filed on Sep. 22, 2010 now is U.S. Pat. No. 8,083,392 Light fixture with self-power removable LED unit(s).

The Page 1 is US patent application publication on May 3, 2012 sheet 7 of 9 US 2012/0106202 for FIG. 7a and FIG. 7b.

The page 2 is US patent application publication on May 3, 2012 sheet 8 of 9 US 2012/0106202 for FIG. 8a and FIG. 8b.

The page 3 is US patent application publication on May 3, 2012 sheet 9 of 9 US 2012/0106202 for FIG. 9a and FIG. 9b and FIG. 9c and FIG. 9d.

Thoe show all for LED track light has removable or add-on or detachable LED unit(s). The current invention is continuously filing basing on the earlier co-pending filing.

FIG. 1 disclosure the preferred embodiment which has high-reflective metal top cover to make the inner under roof LEDs light beam make multiple times reflected and all light beam emit out from top lens.

FIG. 2 disclosure the one embodiment which is one of market items powered by battery which has no any hi-reflective housing or walls to make multiple times reflection. LED-units install on deep base PCB so can get enough distance from LEDs to top lens so light device become very thick around 33 mm only with AAA 10 mm dia. Battery. This LEDs under top lens difficult to solve lighted-spots because LED directly to hit the top lens.

FIG. 3 disclosure the other thick LED light which has the LED(s) installed on the higher level PCB so the LEDs to top lens is very short to get the small area been illuminated such as top white circuit, so need more LEDs to make

Whole top lens be illuminated. This increase LEDs equal to increase power consumption and shorten battery life. This LEDs under top lens difficult to solve lighted-spots because LED directly to hit the top lens.

FIG. 4 and FIGS. 4A-4C disclosure the One preferred embodiment which all LEDs is under top cover roof and light beam not directly to emit to top lens, so without the bright-spots to be seen from top lens. The dot-lines show the edge of roof of top cover.

From FIGS. 4D-4G show the relation for the Top lens, hi-reflective top cover, top cover edge line, LEDs, hi-reflective PCB, hi-reflected wall and relative position so can make the LED light beam reflected for multiple-times and majority or even all emit out from top lens.

From FIGS. 4H-4J disclosure the details light beam traveling from under top cover roof LEDs to hit the hi-reflective housing, top cover, wall back-and-forth within the sealed top compartment. No any light will leakage out from top compartment and light beam only emit out from top lens.

FIG. 5 disclosure the detail arrangement for LEDs arrangement on PCB to prevent LEDs light beam direct to emit to top lens. Also, FIG. 5 disclosure the hi-reflective wall surrounding all LEDs to make all light beam not leakage to back of wall areas. From FIG. 5 the said PCB surface preferred use hi-reflective white color with smooth or diffusing surface so all light emit into can reflected back to top lens and not waste or reduce output light brightness.

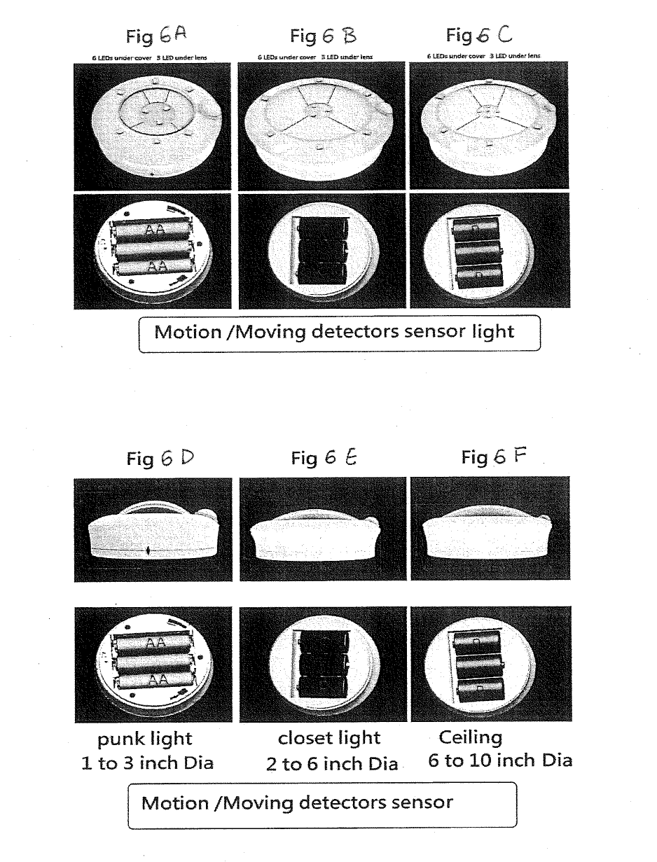

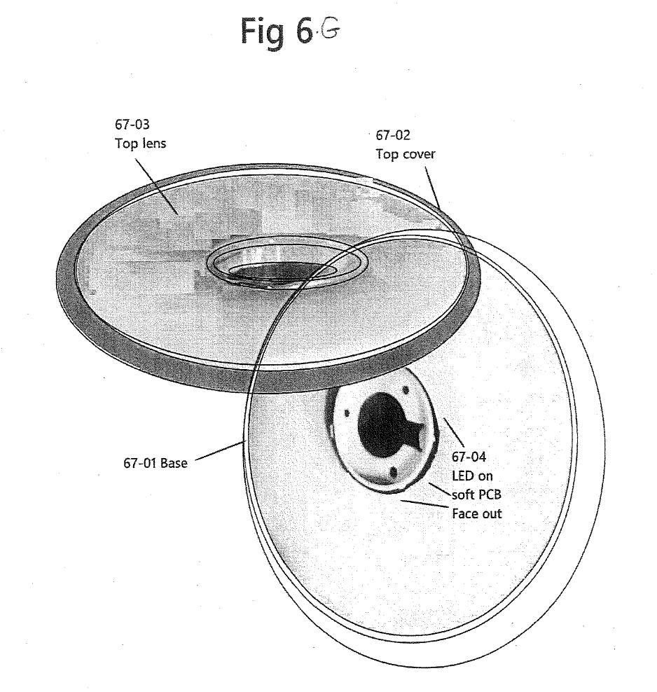

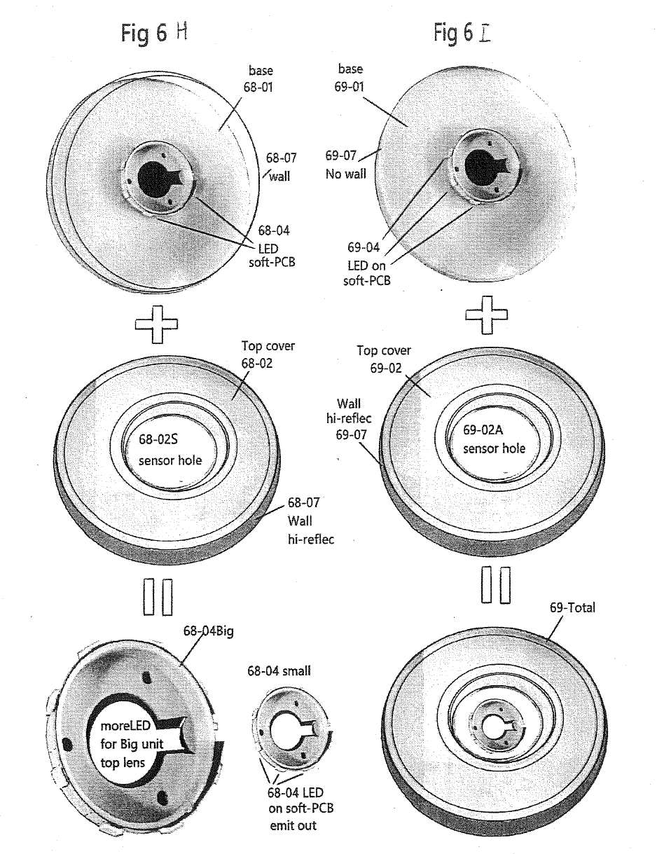

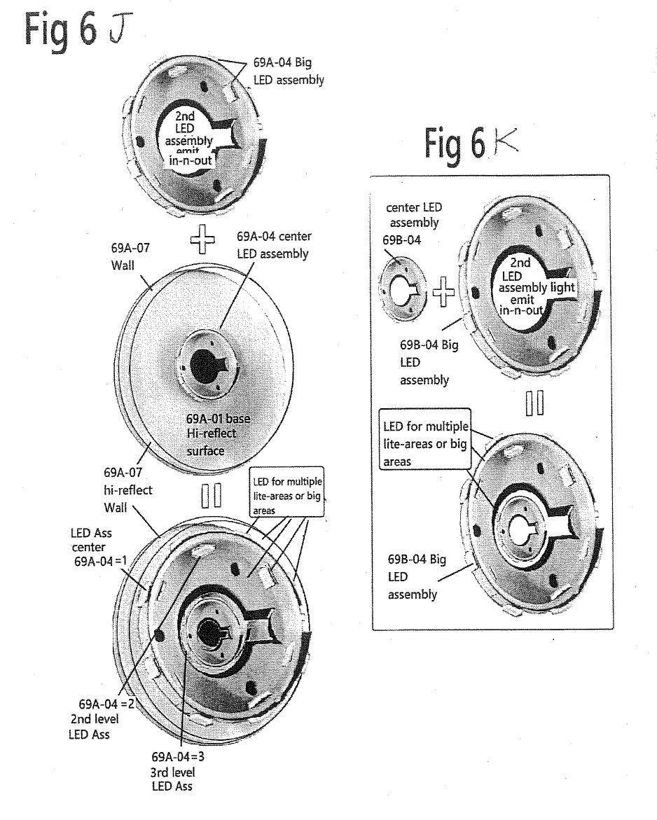

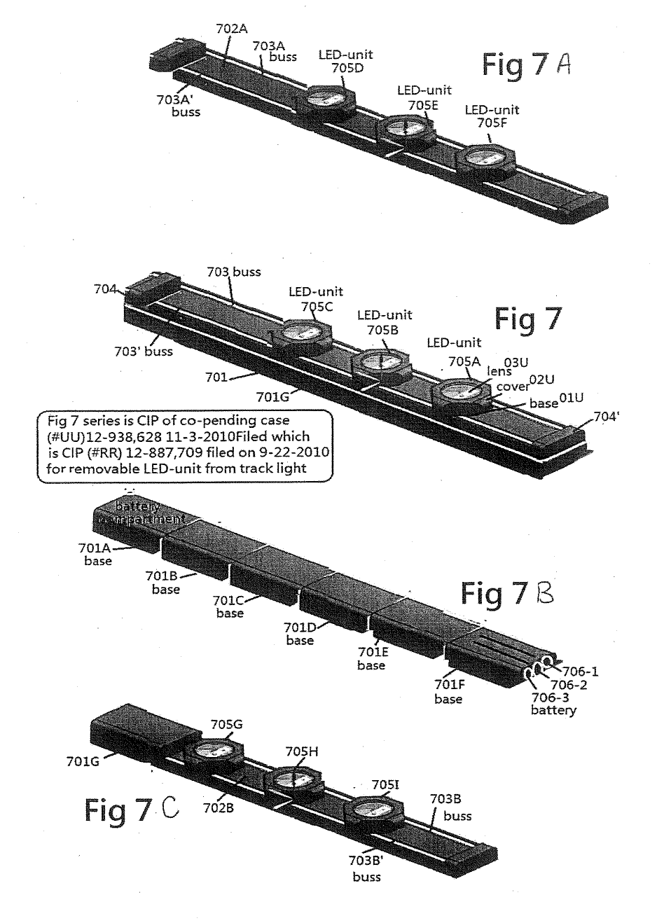

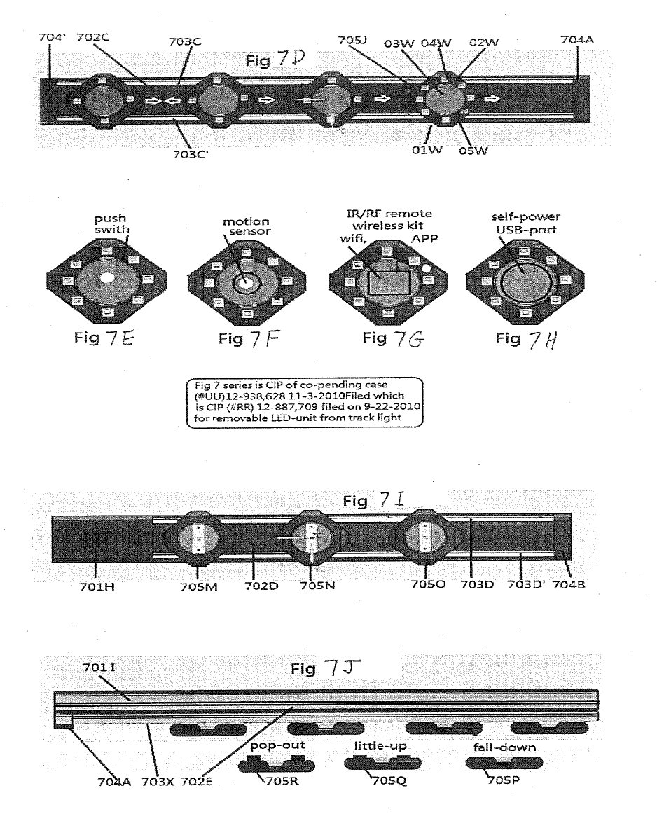

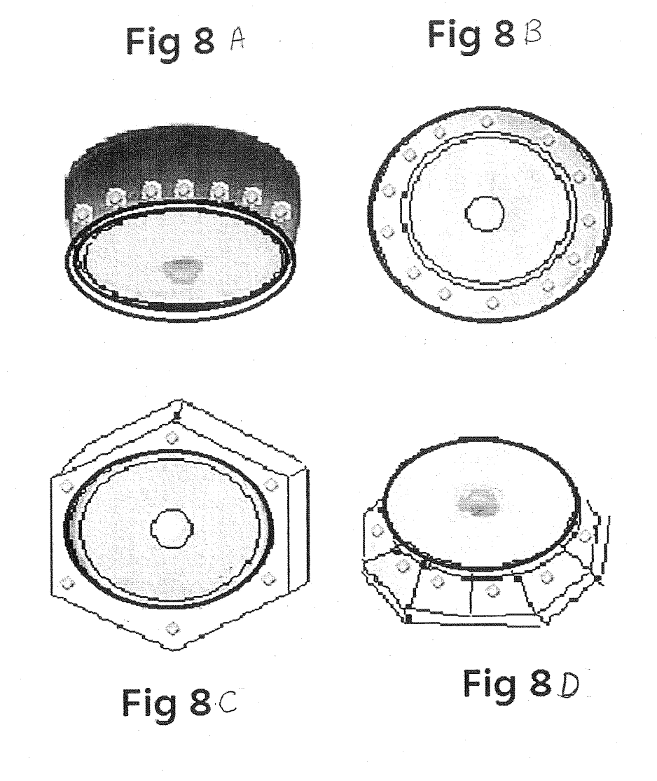

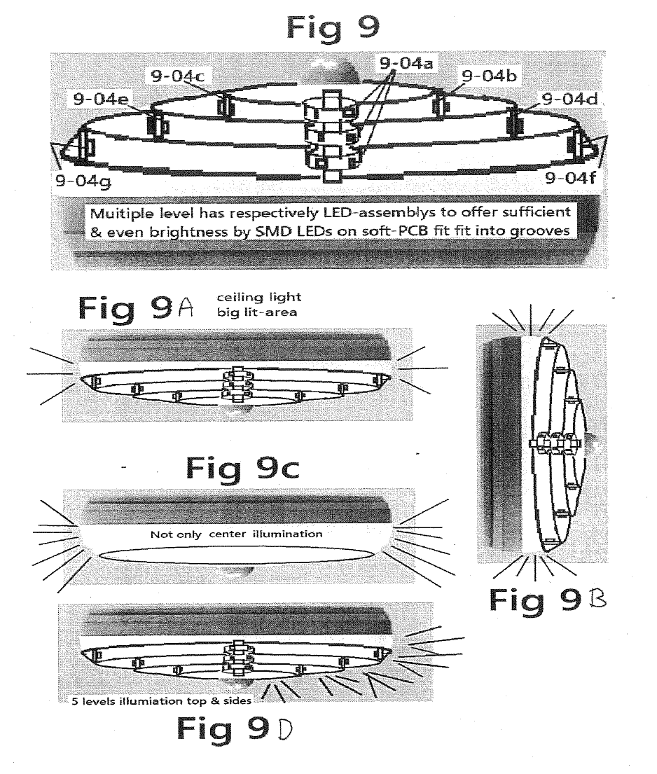

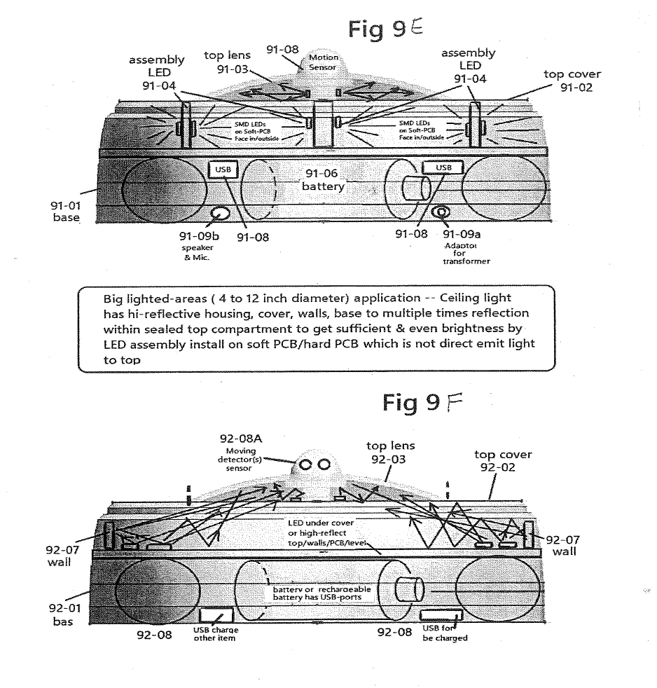

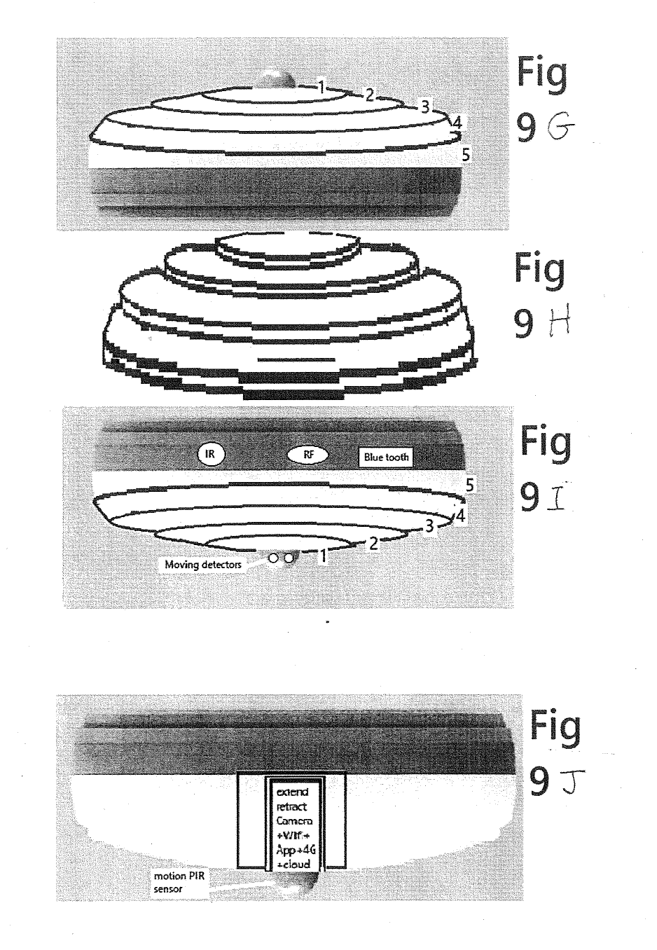

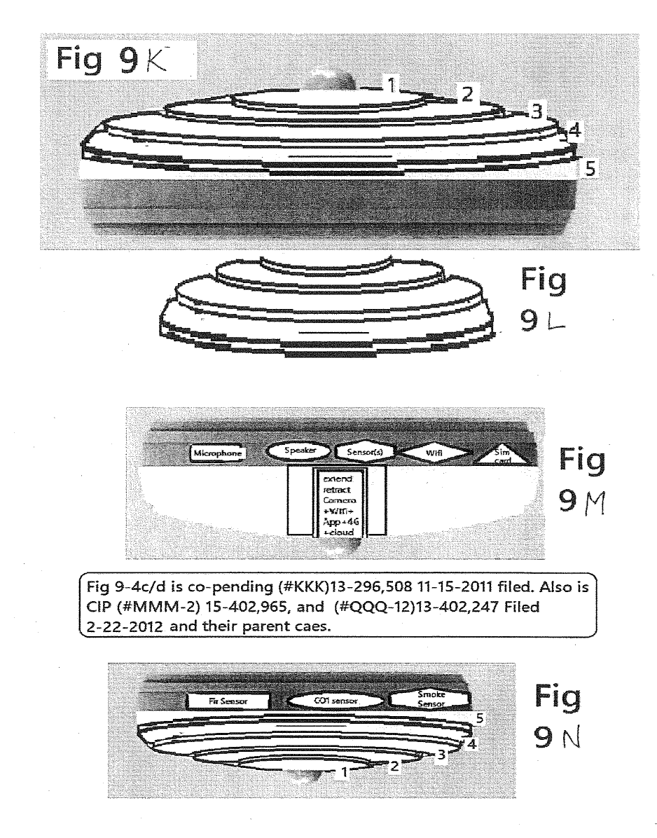

From FIGS. 5A-5C disclosure the current invention for super slim or thin LED light and no any bright-spots can be seen from top lens. From FIG. 5A can see the plurality of LEDs under top cover roof. The said LEDs including (1) white color, or (2) multiple colors in one LED, or (3) multiple piece of red, or green, or blue or other single color LEDs. Comparing the FIG. 5B thicker LED light has all kind of LEDs as (1)(2)(3) on deep low position PCB so can get each LED light beam can spread out to as wider as possible areas of top lens. The thicker light device min has to have 38 mm thickness which is much thicker than FIG. 5A only has 24 mm and FIG. 5-3 only has 28 mm for same battery diameter. So to arrange LEDs under top cover roof incorporate with hi-reflective housing, surface, PCB surface or wall, so can get super slim or thin LED light device and cannot see any lighted-spots from top lens.

From FIGS. 6A-6F show 3 models motion/moving detectors sensor light for many different applications including closet light, under cabinet light, ceiling light, garage light, front entrance door light, patio light, working room, play room for illumination which can has different size 3/4/5/6/7/8/9/10 . . . inch diameter with preferred 100/200/300 or other lumens for brightness. The Drawing has 2 group of LEDs arrangement. The center is LEDs install under top lens which is thicker LED light. The other LEDs install under the Top cover roof so all light beam will be sealed within the top compartment and not leakage to any other place except the Top lens . . . So can use less LEDs number because not like the LEDs under top lens which light beam emit to everywhere, so reduce the light brightness than current invention.

FIGS. 6G to 6K show details of the motion detector sensor lights of FIGS. 6D-6F.

From FIG. 7 and FIGS. 7A-7C disclosure the current to apply the super thin and no bright-spots LED light for track light application for DC power has DC power inside lower compartment. It also can powered by AC power with AC-to-DC circuit which can be built-in of LED-unit, or light device or external AC-to-DC transformer with plug to connect with light device receiving end or ports or terminal.

From FIG. 7 disclosure the LED track light which has pairs of magnetic buss-strips fit into groove and has 2 ends go through the top half plastic housing to connect with below PCB. The PCB has all electric parts & accessories and other lower surface has built-in battery installation metal terminals so battery can directly attach on PCB lower surface without need an extra plastic-plate between PCB to lower-half plastic base. The lower compartment can fit batteries from 2 ends or from bottom doors or cover.

From FIG. 7A disclosure the top-half cover has pairs of groove to allow magnetic buss-strips to fit within and top-half cover also has 2 opening on 2 end of groove to allow the magnetic buss-strips 2 ends go through to connect with PCB assembled inner surface of top-half cover. The said PCB has all functions electric parts and accessories and also has battery installation conductive terminals so can allow people to install batteries from 2 ends or bottom cover or door of LED device.

From FIG. 7B disclosure the lower-half plastic housing of LED light device which may be in one “U” shape piece to join together with top “ [symbol] ” shape by assembly set. Or, the compartment can be battery-pack-assembly use many

Piece of the battery-pack to assemble together and each linkable to deliver power or current.

From FIG. 7C disclosure the other preferred embodiment which the DC power pack is designed on top of LED light and on end location.

From FIG. 7D disclosure the one of embodiment which has 3 magnetic reaction LED-units attached on the magnetic buss-strips and can turn on-off basing on preferred trigger may select from (1) Push on/off switch (2) Motion/moving detectors sensor (3) IR or RF remote controller (4) blue-tooth connection (5) Wi-Fi and-or App with or without 3G/4G/5G network or-and server/cloud storage stations. The functions can install each individual LED-unit has self-power or can install on light device circuit board so can operate single LED-unit or all LED-unit depend on pre-determined functions wanted.

From FIG. 7E disclosure the LED unit has push on-off switch on center of top lens to turn on-off one LED-unit,

From FIG. 7F disclosure the LED unit has center dome motion sensor or pair of moving detector(s) sensor to trigger the said one LED-unit to turn on,

FIGS. 7G-7H show the LED unit housing has built-in wireless receiver to reactivate or reaction with IR/RF transmitter, or Wi-Fi or-and APP wireless signals from electric communications device to turn on the said self-powered LED-unit.

From FIGS. 7E-7H while the Functional parts & accessories is built-in light device. It can use same trigger to turn on-off all the said related LED-units at the same time while each LED-unit install on the magnetic buss-strip and electric connection with the said functional circuit which is built-in on each LED-units or-and built-in at light device

Depend on pre-determined functions. The current discussion is one of preferred not limited for any alternative, equal function, replaceable skill on the art for functional circuit installation and turn on-off one or whole LED-units on the buss-strips or away from the buss-strips.

From FIGS. 7I-7J show the LED-unit(s) install on the magnetic buss-strips for front view and side view.

From FIG. 7J show the (A) conductive movable contactors (B) only magnetic contactors on the back of LED-units for

Flat(fall down)→Little reactivated by magnetic force→Full reactivated by magnetic force (Pop-out). The magnetic contactor to make (pop-out) or (fall-down) can use all market tradition skill to make this functions so not discuss more details.

From FIGS. 8A to 8D show the current preferred super slim and no bright-spots LED light device apply for battery powered ceiling light, closet light, palor light, front entrance door light, back yard light, garage light, Patio light, cabinet light or high-locations installation light application. All the LED(s) light source are install under the housing roof, not under visible top lens has hi-reflective surface, housing, walls, or PCB surface to make multiple times reflections and emit out from top lens only!!

From FIG. 9 show to get sufficient brightness and even brightness for Big lit-areas arrangement. This only can use the soft and bendable PCB has desired number (No. from 1 to N, N=any number) of SMD LEDs on its surface so can make a circle or geometric shape to let all SMD LEDs face inward or outward to cover certain areas. All the LED light beam be reflected by hi-reflect surface, wall, housing, parts and no leakage out from top compartment so can offer the in-direct LED light beam emit out from top lens. If need brighter, can add SMD LEDs number because these in-direct LED light beam been traveling for multiple reflected so it will be very even and none bright-spots can be seen for soft light and good for people eye protection.

From FIG. 9, See the total 5 levels. Each level can have tall wall or not depend on design requirement.

From FIG. 9 is desk top application or other camping application by battery which can offer great illumination and wider to cover not only 180 of front but also cover the sides illumination up to 270 degrees for whole angle.

From FIGS. 9A-9D show the illumination for top ceiling installation. Same the features are not only the front 180-degree flat top-lens can emit light but also the sides can also emit light so can get 180 degrees flat+two side each may up to 45 to 60 degree=so total can add 90 to 120-degree top of the 180 degrees=300 degrees or other alternative design for angles. So it an offer walking closet or front door or garage or patio or garden for top installation ceiling light has 4 to 20-inch diameter or other geometric shape lit-areas with one or more than one levels/steps for in-directly LED light beam.

From FIG. 9B show the increase each level or steps height so can make variety of design.

FIG. 9E show the alternative and same as above has in-direct LED light beam to the top lens but not under cover, housing, roof of housing or parts. The SMD LEDs is install on flexible PCB or substrate so can bendable into circuit shape install on the housing groove to emit the light inward or outward depend on where need to light. It also has the hi-reflective surface or walls or top cover to make multiple times reflection within the top compartment which has no light beam leakage out.

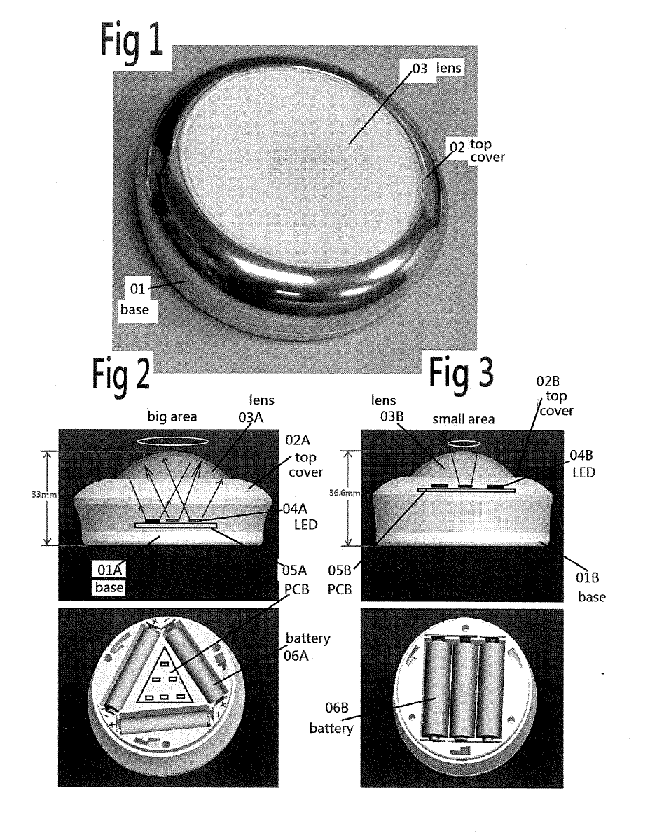

FIG. 9F show the same as the FIG. 1 to FIG. 6 all related drawing which PCB is hard piece and has top cover, roof, housing, parts to prevent light beam direct to see from top lens.

However, for Big lit-areas to has even and super strong light brightness and even photometric, this is not workable so this treatment only can apply for the LED light lit-area less than 4-inch diameter or same square lit-areas for geometric shape for lit-area. Bigger than 4 inch diameter up to 20 inch for lit-area only can use the FIG. 9-1 or following FIG. 9 for LED-assembly or more than one of LED assembly to get big lit-areas or multiple level lit-areas or top/side illumination purpose. The hard PCB and SMD face up is too costly to make big areas illumination because bigger size PCB is more expensive. Especially the current requirement for all LEDs under cover, housing, parts to get the in-direct light beam show on the top lens so it is too costly for SMD LEDs all face up on hard PCB.

From FIGS. 9G-9H show the 5 level or steps top-lens has not only front illumination and also has good brightness emit from side so increase the illumination for more areas and not only front side of LED light. The FIG. 9-3a which is shallow disk like top lens, not same as FIG. 9-3b which each level or step has high wall so more look like 5 steps.

From FIGS. 9I-9J show other application for motion or moving detector(s) sensor ceiling light has 3 to 20-inch diameter for round or any geometric shape. Also the added functions or features is all same as co-inventor's earlier or pending filed case including it and all related parent filed case such as (# KKK) U.S. application Ser. No. 13,296, 508 filed on Nov. 15, 2011 and (# MMM-2) U.S. application Ser. No. 15,402,965 filed on Feb. 22, 2012.

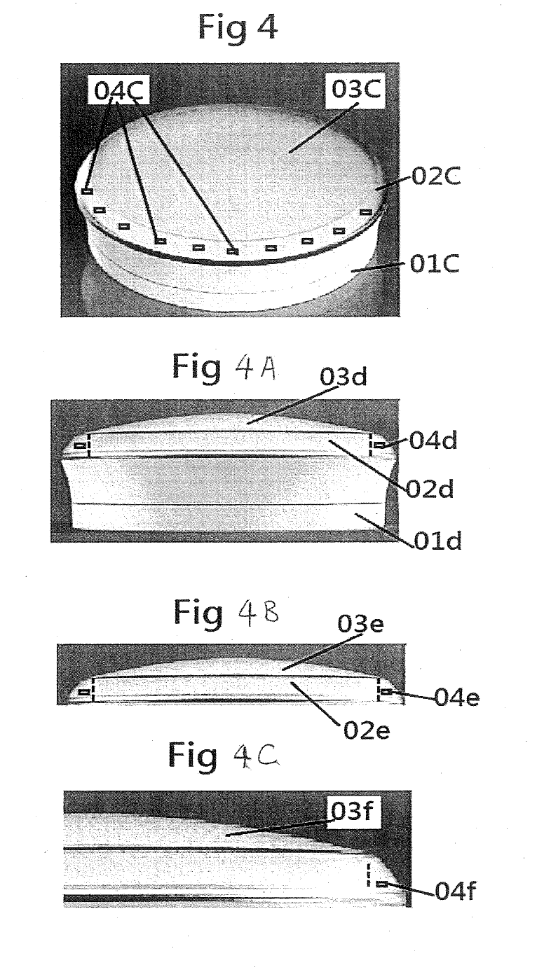

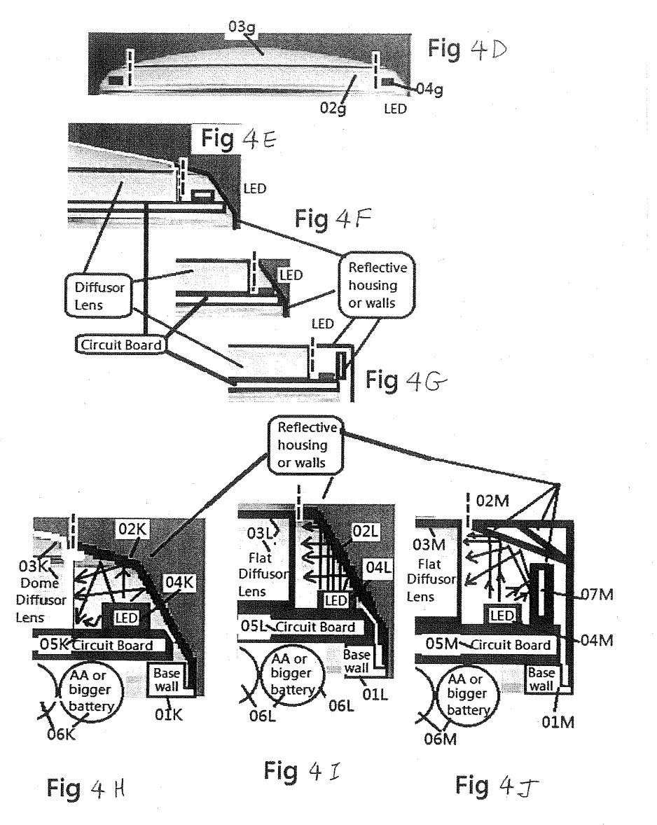

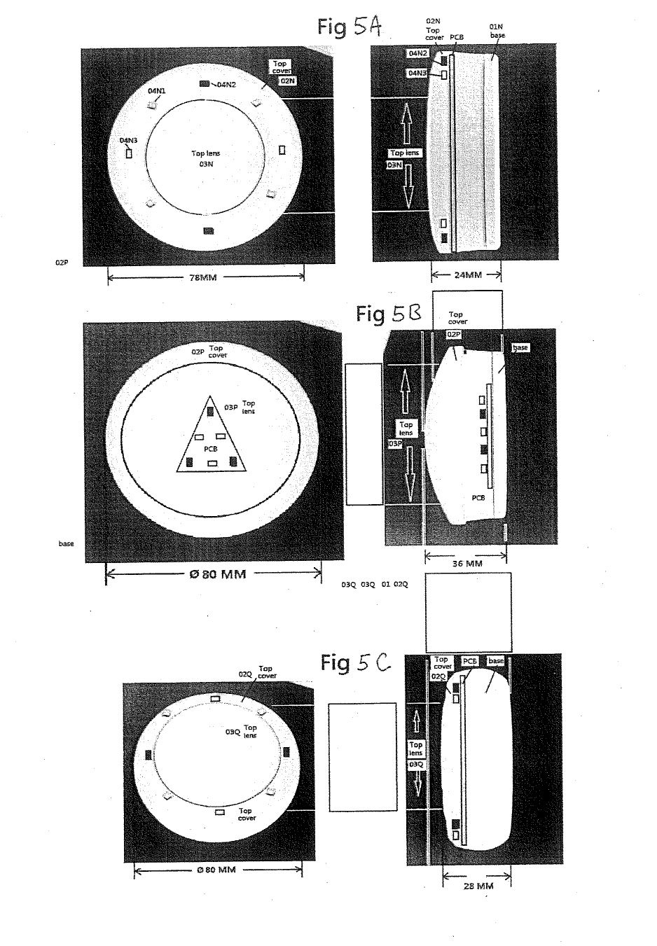

From FIGS. 9K-9L show the same as FIGS. 9I-9J but different at 9-4a is motion sensor and FIG. 9-4a is moving detector(s) sensor.

From FIGS. 9M-9N same as above FIGS. 9I-9J. Also the added functions or features is all same as co-inventor's earlier or pending filed case including it and all related parent filed case such as (# KKK) U.S. application Ser. No. 13,296, 508 filed on Nov. 15, 2011 and (# MMM-2) U.S. application Ser. No. 15,402,965 filed on Feb. 22, 2012. show all other features or functions can add into the current big lit-area application such as ceiling light or wall mounted light of battery or wired or plug-in LED light.

### DETAILS DESCRIPTION

First 3 pages is co-pending (#UU) Ser. No. 12/938,628 (Nov. 3, 2010 F) (Public US 2012-010-6202) May 3, 2012=Has (#RR-10Drawing)&(T→change to I=Bendable vs Qirky). The public No. US 2012/0106-6202 drawing for LED track light has added-on ad detachable LED unit(s)

And the same drawing show on the Child Filed case;

(#RR-2010) Ser. No. 12/887,709 Filed on Sep. 22, 2010 now is U.S. Pat. No. 8,083,392 Light fixture with self-power removable LED unit(s).

The Page 1 is US patent application publication on May 3, 2012 sheet 7 of 9 US 2012/0106202 for FIG. 7a and FIG. 7b.

The page 2 is US patent application publication on May 3, 2012 sheet 8 of 9 US 2012/0106202 for FIG. 8a and FIG. 8b.

The page 3 is US patent application publication on May 3, 2012 sheet 9 of 9 US 2012/0106202 for FIG. 9a and FIG. 9b and FIG. 9c and FIG. 9d.

Thoe show all for LED track light has removable or add-on or detachable LED unit(s). The current invention is continuously filing basing on the earlier co-pending filing.

The current invention has 53 major features as below list which offer a power saving and easy installation LED-unit(s) which has pop-out and fall-down movable contactor on the back of LED-unit and connect with bus-strips has magnetic force so can deliver the electric power from magnetic bus-strip which also carry the electric current. The LED-unit at least has one pair of contactor so can built-up the electric delivery from bus-strips and the pair of contactor connect with inner circuit and LEDs without polarized so can make any connect the pair contactor to any way to magnetic bus-strips.

so can much easier for people to make assembly (Not show on drawing). It also has very limited number of LED-unit(s) install on track which total LED-unit(s) lighted length may only ⅕, ¼, ⅓, ½ of the total track light length and total length at least can offer one people shoulder width illumination so people can move the shoulder-width LED-unit(s) to right position within the track and lighted the shoulder-width areas for work.

This is very good to only offer limited shoulder-width LED-unit inside track so can let people save a lot of cost than conventional full loaded LED(s) for total track length. Not only save power consumption but also save a lot of cost so can encourage people to replace non-LED products to LED fluorescent tube products because below listed 21 features.
1. A DC powered LED light device optics arrangement comprising:
   At one LED as light source to offer brightness.
   At least one high reflective housing or wall to offer light beam for multiple times reflected or-and refracted and emit out from top lens lit-area(s).
   LED install on circuit board that that is a divider to form a compartment which only has LED(s), high reflective or-and refractive housing or parts, upper-side of circuit-board, lens.
2. A DC powered LED light device optics arrangement, the said high reflective surface is a housing or wall or parts which make LED light beams has multiple times reflected before emit to the lens.
3. A DC powered LED light device optics arrangement, the said light beam emit out from lens after multiple times reflected or-and go through lens refractive properties so offer wider and strong light beam.
4. A DC powered LED light device optics arrangement, the said LED is install under the light-block material housing, cover, ring, roof and not under the lens lit-area.
5. A DC powered LED light device optics arrangement, the said LED is white or red or green or blue or multiple colors (SMD) surface mounted type or Dip type.
6. A DC powered LED light device optics arrangement, the said LED is turn on or turn off by switch, motion or moving detector(s) sensor, remote controller, wireless system, integrated circuit (IC) for steady or moving or color changing effects or automatic changing & freeze color function, performance, light show.
7. A DC powered LED light device optics arrangement, the said light beam only travel within the said compartment and emit out from lens.
8. A DC powered LED light device optics arrangement, the said high-reflective surface or housing or parts is at least one of (1) high polished plastic, or (2) mirror-like metalized plastic, or (3) shinning metal piece and (4) white upper-side circuit board.
9. A DC powered LED light device optics arrangement, the said circuit board lower-side is face down and has electric parts and accessories to connect LED(s) with DC power source select from battery or rechargeable battery or device has USB-ports to offer DC power.
10. A DC powered LED light device optics arrangement, the said high reflective wall is surrounding all LEDs inside the wall so all light will not leakage out from wall and light beam reflected by wall back to inner lens so all light beam only can travel within the inside of wall.
11. A DC powered LED light device optics arrangement, the said high reflective housing or parts which offer desired angle to let light beam emit into and reflected into the lens.
12. A DC powered LED light device optics arrangement, the said thin LED light made by install SMD LEDs for super slim thickness on circuit board which is divider and lower-side has install battery-contactor(s) so battery can install on lower-side surface to save other plastic added divider which min 1 mm or more.
13. A DC powered LED light device optics arrangement, the said LED(s) functions for steady or moving effects including but not limited select from chasing, random, fade-in & fade-out, pair flashing, color changing, auto color changing or-and freeze color, instant white, dimmable, brightness control, timer for turn on for period of time, by controller or selector through wired or wireless system or transmission.
14. A DC powered LED light device optics arrangement, the said LED(s) control by wireless including blue-tooth connection, IR or RF remote controller, or wireless controller through APP software through the 3G/4G/5G network or Wi-Fi or-and servers, cloud storage stations.
15. A DC powered LED light device optics arrangement, the said LED light has attachment kits to install on closet, under cabinet, bar, or desired locations by screw, phone holes, double side tape, 3M tape, Velcro tape, glue, magnetic, conductive and movable magnetic piece to desired material including wood, metal surface.
16. A DC powered LED light device optics arrangement, the said DC power get from USB-port(s) and USB-wire set from DC power bank of DC electric device has DC current output.
17. A DC powered LED light device optics arrangement, the said DC power including the LED light device has AC input-end(s) to get AC power and go through LED light built-in AC-to-DC circuit.
18. A DC powered LED light device optics arrangement, the said DC power including the LED light has a female adaptor to receiving male plugs come out from outside AC-to-DC transformer, inverter.
19. A DC powered LED light device optics arrangement, the said LED is SMD LED(s) install on the flexible or bendable or soft PCB to allow the bend in geometric shape or circle to allow the SMD LEDs light beam emit inward or-and outward to offer in-direct LED light beam to travel within the compartment.
20. A DC powered LED light device optics arrangement, the said flexible or bendable or soft PCB install under the motion/moving detector sensor or fit within the compartment plastic wall or compartment grooves by attachment kits.
21. A DC powered LED light device optics arrangement, the said flexible or bendable or soft PCB can fit on a pole or bar to offer many levels to offer the different levels or step of lit-area of the said top lens.
22. A DC powered LED light device optics arrangement, the said LED light has disc-shallow shape or multiple levels or steps sphere top cover with or without the sides illumination arrangement.
23. A DC powered LED light device optics arrangement, the said multiple levers or steps LED light top cover has other geometric shape to offer front or-and sides illumination powered by DC or-and AC wired or-and DC transformer.
24. A DC powered LED light device optics arrangement, the said super slim LED light for less than 4-inch diameter or equal lit-areas by flexible or bendable PCB can reduce one of hard PCB thickness so can become super slim and it also will offer whole top lens has even brightness by in-direct LED light beam through multiple times reflected or-and refracted.
25. A DC power LED light device optics arrangement, the said flexible or bendable PCB has SMD LEDs can have as many as sets so can make sufficient and even brightness for multiple levels or steps LED light or super big size lit-area which from four to twenty-inch diameter lit-area has desired perfect illumination on front or-and sides.
26. A DC powered LED light device optics arrangement, the said LED light has conductive and movable magnetic kits which can attached on any metal can reactivated with magnetic force for quickly install and delivery the electric current through the conductive and movable magnetic kits.
27. A light device, comprising:
   at least one track assembly has plurality of magnetic bus-strips to adhesive or install at least one LED-unit which has pop-out or fall-down metal contact(s) on back and the LED-unit(s) install or remove from anywhere along length by magnetic interaction force.
   at least one LED-unit including at least one LED, said LED having predetermined brightness, color, illumination direction, viewing angle, electric signal receiver, IR/RF receiver for offer illumination to area(s);
   the LED-unit including conductive piece which can pop-out or fall-down from back housing openings of LED-unit while metal contactor(s) near the bus-strips magnetic force and it will pop-out and adhesive on the buss-strips for electrically delivery from bus-strips to LED-unit to cause the at least one LED light source(s) to turn on-off under predetermined functions, performance, and duration; and
   the LED-unit having a geometric shape, size, cover, housing, insulation, opening on back for movable magnetic-kits, pop-out or fall-down movable construction, and holding parts that allow a person to move, change position, add, remove, assemble, or disassemble the LED-unit; and
   the LED-units at least has two contactors.

The light device that can use LED-unit back side pop-out and fall-down function incorporate with magnetic bus-strips anywhere along the track length by magnetic force to install LED-unit(s) anywhere for adding or move-out LED-unit(s).

The improvement for LED-units which has at least one or more function selected from (1) has push on-off switch, or (2) has motion or moving detector(s) sensor, or (3) has IR or RF remote control system, or (4) has built-in power source including backup batteries or rechargeable battery.
28. A light device, wherein said pop-out and fall-down metal contactor(s) on the back side of LED-unit to adhesive to the bus-strips has strong magnetic force without polarization poles so contactor(s) can touch any one of pair buss-strip to build the electric power delivery.
29. A light device, wherein said conductive contacts on the back of LED-unit at least one pair or plurality pairs to make color changing for any combination for Red, Green, Blue and White LED(s).
30. A light device, wherein said the magnetic bus-strip on the track at least one pair or plurality of pairs to make contact with LED-unit(s) which has more than one LED light source within
31. A light device, the said and pop-out and fall-down contactors has no polarized difference design so any way to make 2 contactors connect to any way will not cause the inside LED(s) source to damage or electric shortage.
32. A light device, the said LED-unit(s) has IC and circuit to make the LED-unit to have white, one, multiple, changing, auto changing and freeze color function with preferred steady or moving light or jumping light functions from the circuitry or-and IC.
33. A light device, the said power by DC source which has desired compartment under the buss-strips for battery powered application which can have AAA or AA or SC or DD or F battery or rechargeable batteries.
34. A light device, the said power from AC source through the said (1) built-in AC-to-DC circuitry or (2) through the device's adaptor hole or receiving hole to connect with external housing AC-to-DC transformer to get power for light device inner conductive-parts or DC-to-DC circuit to supply related electric parts & accessories which may had different more than one working DC voltage to have desired function, performance, and light illumination.
35. A light device, the said the said LED-unit turn-on and turn-off by (A) push on-off switch built-on LED-unit(s), or (B) by motion or moving detector(s) sensor built-in LED-light, or (C) by IR or RF remote-control system which has outside transmitter and built-in receiver on each of LED-unit to turn on only one LED-unit, or receiver built-in light device for all LED-unit(s), or (D) by Wi-Fi or-and wireless communication and APP software to operate the said one or all LED-unit(s) optional incorporate with server or cloud storage station and 3G/4G/5G or more update networks.
36. A LED light device, comprising:
   at least one track assembly for installing a plurality of different or same of LED-unit anywhere along the length or from end of the track assembly;
   the said each of LED-unit including at least one LED(s) as light source, said LED light source having predetermined specification including brightness, color, illumination direction, viewing angle, and illumination area;

The each of LED-unit has resilient or movable conductive contactors for getting electric-power from bus-strip, or-and built-in circuit, or-and circuit built-in or added-on to the track assembly to cause LED light source to turn on and off according to predetermined controller, functions, performance, and duration; and

the each of LED-unit being arranged to be installed anywhere along the length or inserted into from the end of the track assembly, the LED-unit having selective features including geometric shape, size, cover, housing, insulation, movable contact by magnetic-force and holding parts that allow people to adding or reduce or move or remove number of LED-unit(s) install or attached on the bus-strip, or change number of LEDs of LED-unit, or change position of each LED-unit. The LED-units can move or remove or add to track assembly, change position, add, remove, assemble, or disassemble from the track assembly; and

wherein has protective housing is a housing, or part of housing, cover, lid, shade has light transmitting window(s) or section(s) or area(s) that can open to resembles and replaces LED-unit(s) wherein said protective housing assembled with track-assembly which encloses buss-strip(s) and the plurality of LED-units to form an LED light device.

The improvement;

The track assembly has the said number of bus-strip(s) can delivery electric signal or has magnetic property, and each of bus-strip has number of positive or-and negative electric current to single or-and plurality of single color or multiple color LED light source.

The track assembly and protective housing made by one or more than one piece of plastic or metal material assembled together to form the said light device by screw, catcher, sonic sealing, glue, compound, push tight, fasten items to form a finished light device.
37. A LED light device, wherein the at least one track assembly is assembled by top piece and lower piece or more piece in Z-axis relation and bus-strips fit within between pieces for easily installation the conductive buss-strips.
38. A LED light device, wherein LED-unit is one of a mini-size or compact size of LED application light device including (1) tube-like fluorescent tube, (2) bulb has base, (3) LED light with magnetic to attached on track assembly, or (4) LED light for any construction has base and bendable arms and LED-unit(s) can fit within or attached on track assembly has easily movable function.
39. A LED light device, wherein the resilient conductive contact piece is metal or copper material with round or radius contact-ends so can smoothly move and change position within the track assembly and electrically connect and with the surface of bus-strip.
40. A LED light device, wherein the movable conductive contact piece has metal or copper electric-delivery material as contact to electric pole and connect with bus-strips has magnetic force it will pop-out and make well connection to get electric power or the said movable contact incorporated with built-in magnetic kit and both way contact piece is install on the back side of LED-unit that can attached on anywhere of track-assembly and get power from bus-strip by magnetic kits so can easily add or move-out and change position on the track assembly and electrically connect and disconnect with the surface of bus-strip.
41. A LED light device, wherein the resilient piece deforms upon installation within the space of track-assembly top and lower surface to provide a secure electrical connection between the LED-unit and the bus-strip both are fit-into the track assembly.
42. A LED light device, wherein the LED light device is a fluorescent tube shape which has limited number of tube-like or rectangular shape or linear-shape movable LED-unit(s) those total in x-axis length accumulated is only up to ⅙ or ¼ or ⅔ or more shorter than the track-assembly length so only can offer limited section/area/length of whole LED device length for illuminations, and the LED elements are arranged to illuminate a predetermined area only corresponding and each section or areas for illumination width is close to a people's shoulder width to minimize a number of LED-unit numbers which also reduce LED(s) number to reduce power consumption and cost than the market LED fluorescent tube like light device has big number of LEDs along the whole length.
43. A LED light device, wherein the LED light device is a fluorescent tube light which has section(s) or area(s) of whole device length having movable LED unit(s) to offer limited location illumination and the locations illumination width in x-axis is close or corresponding to a people's shoulder width to minimize a number of LED-unit(s) or LED light source(s) and reduce electric power consumption than the market LED tube-like light device has big number of LEDs fill along the whole length.
44. A LED light device, wherein LED light device is assembled of track assembly and protective housing which has window or lip or cover can open to make change or adjust or repair the inner LED-unit(s) related parts and accessories.
45. A LED light device, wherein LED light device has protective housing to protect inner bus-strips and LED-unit(s) and prevent from people to touch without open the window, lip, cover which has hinge or other joint-kits to allow can open to make adjustment or replacement.
46. A light device, wherein said plurality of LED-units have different arrangements of one or more of said LED light source selected from differences in type, size, shape, pattern, number, color, electric terminals, number of surfaces, brightness, diameter, service like, and function.
47. A light device, wherein said the LED unit has magnetic kits which is install on the center of back of LED unit so can get interaction for magnetics kit with center raised of metal parts of the track-assembly to hold the LED-unit on position without fall down.
48. A light device, wherein said the said LED light device is power source is from AC power from outlet of housing, residence, building.
49. A light device, wherein said the said LED light device power source is a DC power source from batteries, rechargeable battery, AC-to-DC transformer, energy storage device for solar power, wind power, chemical power, water power.
50. A LED light device, the said the said protective housing at least includes first and second protective members, the first or-and second protective member being integrally combined with or combined to form the track assembly,
51. A light device, the said the said first protective member is secured to the track-assembly by at least one hook-shaped catch, screw, fit tight, ultrasonic, glue,
52. A light device, the said the said wherein said first and second or more protective members together form a tube or bulb shaped protective member enclosing said track assembly and said at least one LED-unit.
53. A light device, comprising:
   at least one track assembly has plurality of magnetic bus-strips to adhesive or install at least one LED-unit which has pop-out or fall-down metal contact(s) on back and the LED-unit(s) install or remove from anywhere along length by magnetic interaction force.
   at least one LED-unit including at least one LED, said LED having predetermined brightness, color, illumination direction, viewing angle, electric signal receiver, IR/RF receiver for offer illumination to area(s);
   the LED-unit including conductive piece which can pop-out or fall-down from back housing openings of LED-unit while metal contactor(s) near the bus-strips magnetic force for electrically delivery from bus-strips to each LED-unit to cause the at least one LED predetermined functions, performance, and duration; and
   the LED-unit having a geometric shape, size, cover, housing, insulation, opening on back, pop-out or fall-down movable construction, and holding parts that allow a person to move, change position, add, remove, assemble, or disassemble the LED-unit; and
   the LED-units at least has two contactors.

The light device that can use LED-unit back side pop-out and fall-down function incorporate with magnetic bus-strips anywhere along the track length by magnetic force to install LED-unit(s) anywhere for adding or move-out LED-unit(s).

The improvement for LED-units which has at least one or more function selected from (1) has push on-off switch, or (2) has motion or moving detector(s) sensor, or (3) has IR or RF remote control system, or (4) has built-in power source including backup batteries or rechargeable battery.
54. A light device, wherein said pop-out and fall-down metal contactor(s) on the back side of LED-unit to adhesive to the bus-strips has strong magnetic force.
55. A light device, wherein said conductive contacts on the back of LED-unit at least one pair or plurality pairs to make color changing for any combination for Red, Green, Blue and White LED(s).
56. A light device, wherein said the magnetic bus-strip on the track at least one pair or plurality of pairs to make contact with LED-unit(s) which has more than one LED light source within
57. A light device, the said and pop-out and fall-down contactors has no polarized difference design so any way to make 2 contactors connect to any way will not cause the LED(s) inside LED-unit to cause electric shortage.
58. A light device, the said LED-unit(s) has IC and circuit to make the LED-unit to have white, one, multiple, changing, auto changing and freeze color function with preferred steady or moving light or jumping light functions.
59. A light device, the said power source compartment is under the buss-strips for battery powered application which can have AAA or AA or SC or DD or F battery or rechargeable batteries.
60. A light device, the said power from AC source through the said built-in AC-to-DC circuitry or external housing AC-to-DC transformer to supply to the light device conductive-parts or DC-to-DC circuit to supply to related electric parts & accessories to have desired function, performance, and light illumination.

From above list 60 features for LED light has optic-arrangement so it can make not only no bright-spot see from top lens but also can make super slim or thin LED light as finish product or become parts for other light device application. The Finished products for this optic design is perfect for any purpose light including indoor or outdoor use such as ceiling, room, garage, garden, patio, cabinet, under cabinet, door light etc.

While the LED light optic-design become parts for some application such as LED track light as LED-units such as co-pending PARENT FILED case (#UU-2010) U.S. application Ser. No. 12/938,628 (Nov. 3, 2010 F) (Public US 2012-010-6202) May 3, 2012=Has (#RR-10 has Drawing for movable or removable or attachable or detachable LED-units. The (#RR-2010) also including transforming shape construction drawing from T shape→change to I.

Please see above attached (#RR-2010) public No. US 2012/0106-6202.

The (#UU-2010) U.S. application Ser. No. 12,938,628 filed on Nov. 3, 2010 and still pending and is CIP or Division of (#RR-2010).
(#RR-2010) or (#UU-2010) application Ser. No. 12,938,628 both are Parent of (#T-1) U.S. application Ser. No. 12,894,865 filed on Sep. 30, 2010.
(#HHH-2011) U.S. application Ser No. 13,162,824 filed on Jun. 17, 2011. (#LLL-2012) US application Ser. No. 13,267,687 filed on Feb. 7, 2012.
(#LLL-2017) U.S. application Ser. No. 15,458,498 filed on Mar. 14, 2017.

These co-pending cases mainly for LED track light has removable or detachable LED-unit. The current invention makes the big improvement for power saving LED-unit, Super Slim LED-unit, Super easily attachable LED-unit by magnetic-reaction on track light.

Further incorporate with the different circuit or-and controller or-and update wireless communication not only the earlier parent case for Blue-tooth connection but also has incorporate with Wi-Fi, APP software, Server, Cloud, 4G/5G network to make more simple and easily and more selections control the (1) brightness (2) mixed color (3) dimmable (4) time period for illumination (5) instant white (6) 360 or more color mixer (7) add camera for MP4 image and sound (8) communication with phone or computer or communication equipment, consumer electric.

From Parent filed case and pending case the current invention also including the self-powered LED-unit so can have added feature for said track light LED light source and can carry to everywhere. (As #RR-2010 and #UU-2010).

From Parent filed and co-pending filed cases also has features for

From FIG. 1 show the current invention has hi-reflective top cover (02) to assembled with base (01) and has top-lens (03) for form a finish products use for ceiling while it between 5 to 15-inch diameter with sufficient light brightness from 100 to 1,000 Lumens. While the size made from 1 inch to 6 inch can become parts of other main application such as LED-unit(s) for track light which has preferred installation or attachment with detachable features as co-pending or earlier flied case list above.

From FIG. 2 show the thicker unit which is too bulky for user and look bad because has (1) thicker or too high (2) can see high bright-spots from lens while it lit (3) too much opaque or white painting or powder while injection or treated so inside light beam been block out up to 20 or up to 50% just only for not see the LED light spot. This is not power saving or not smart to make a LED light. From FIG. 2 show the LED light source (04) is install on the bottom of base PCB (05). The reason why need to put PCB (05) as deep as possible because LED light source (04) is narrow light beam light source if need to get wider area (Top White circle area) been lighted need to have as long as distance from LED to light present location. From FIG. 2 compare with FIG. 3 which PCB (05) is put upper location so the lighted-area (FIG. 3 top white circle is very small). From Both FIG. 2 or FIG. 3 because LED light source (04) all install under the top lens (03) and any LED light strong beam will still show out to people and that is not comfortable and hurt people eyes. From FIG. 2 lower photo show the 3 batteries (06) arranged as triangle in order to let center space empty so a put the PCB as deep as to get wider lighted-area. However, from FIG. 3 the battery is put on parallel so no space within the batteries so PCB (05) have to move up and this cause seriously tiny lighted-areas and super strong LED bright-sports, so only solution to get even brightness for whole top lens only can make top lens more white and which means need reduce a lot of brightness just make even brightness and no lighted spots.

From FIG. 4, FIG. 4-1, FIG. 4-2, FIG. 4-3, FIG. 4-4 show the current invention optics design for LED position. Basing on market may need super bright LED light so may need use plurality of LEDs for offer sufficient brightness. The smartest way is use SMD (Surface Mounted) which can use automatically machine to install plurality of LEDs in seconds without any deviation, shortage instead of Dip type LED has 2 or more legs need soldering on PCB. From FIG. 4, the current invention prefers to use all SMD LED which is around 1×3 mm size by automatically installation. All SMD LEDs (04c) are install PCB (05c) and all LEDs (04c) is under the light block-out material top cover (02c) or housing (02c), so the LED (04c) light emit to up and do not be seen by people.

From FIG. 4-1, FIG. 4-2, FIG. 4-3, FIG. 4-4, FIG. 4-5 show the same unit as FIG. 4 just make parts larger and larger to show clear the top cover (02d) (02g) (02e) (02f) edge (dot-line) and LED(s) (04d) (04e) (04f) position. It also shown the Top lens (03d) (03e) (03f) and Top Cover (02d) (02g) relation. Here the slim LED light has shallow disk-like shape for cosmetic purpose. It can be totally flat for more fashion model and look more thin unit.

From FIG. 4-5 and FIG. 4-6 and FIG. 4-7 show bigger size drawing to show the different top lens and top cover and LEDs location vs. top cover edge (Dot-line). And also show the PCB (circuit board) which is just under the LEDs and PCB is also act a divider to make the top compartment is totally sealed for light beam emission. All light beam only can be traveling within the top compartment which has only Top cover, Top lens, LEDs and one side of PCB. Also, the inner surface of top cover and one surface of PCB both preferred has hi-reflective property treatment such as inner surface of top cover is metalized treated as mirror like shinning and PCB top surface preferred use white color surface so any light emit out from LEDs will hit mirror like top cover with pre-determined angle so can get best light reflected to the top lens. Alternative the top cover can made out from metal material and still has mirror light for inner surface with preferred angle design so can max light beam reflected to the top lens. The top compartment has well design all light beam only can emit out from top lens. The top lens can be fully transparent so only has 1% or less % light loose because current invention all LED light source is not under top lens so no need a lot of texture or white painting to prevent people to see bright-spots. At this optics-design will get max. LED output light been applying for illumination only. The said the current invention has LEDs under light block-out roof plus hi-reflective housing or top cover can apply any LED light device.

From FIG. 4-5-1 can see the relation of top lens (03K) is a shallow dish-like shape and top-cover (02K) which may made by metalized plastic or real metal piece has hi-reflective property which reflected LED (04K) and emit to the top lens (03K). The PCB (04K) which become a divider to make whole top compartment has no any light beam leakage to lower portion or any other location. Any light beam will be reflected by mirror like hi-reflective surface including inside of top cover, housing and PCB top surface.

From FIG. 4-6-1 can see the relation of top lens (03L) is a totally flat shape and top-cover (02L) which made of metalized plastic or real metal piece has hi-reflective property prefer like mirror and had optic angle calculation which has almost 45 degree so can get maximum reflections. The said top cover (02L) can get maximum and best reflection. The LED (04L) light beam has this 45 degree optics reflective angle so can get maximum light beam emit to the top lens (03L). The PCB (04L) which become a divider to make whole top compartment has no any light beam leakage to lower portion or any other location. Any light beam will be reflected by mirror like hi-reflective surface including inside of top cover, housing and PCB top surface.

From FIG. 4-7-1 can see the relation of top lens (03M) is a totally flat shape and top-cover (02K) which made of metalized plastic or real metal piece has hi-reflective property prefer like mirror and can be any optic design or construction such as 90 degree or 45 degree or 60 degree or add a reflective wall surround all the LED-units. These four different optics-design has tiny difference as long as the top compartment is no any light beam leakage out and all light beam only emit from top lens (03M). No any leakage light beam from top compartment so means all the light beam is traveling within only the top compartment and has multiple times reflected or-and refracted by the top lens, so all light beam from LED (04L) almost 100% emit out from the top lens (03L). The PCB (04L) which become a divider to make whole top compartment has no any light beam leakage to lower portion or any other location. Any light beam will be reflected by mirror like hi-reflective surface including inside of top cover, housing and PCB top surface. The wall (07M) install on the PCB (05M) and wall (07M) has height up to top cover so no any light beam will leakage from back all LEDs (04M).

From FIG. 4-5-1 and FIG. 4-6-1 and FIG. 4-7-1 also shown the how the top cover (02K) (02L) (02M) to join with the PCB (05K) (05L) (05M) for base wall (01K) (01L) (01M) and also show the preferred battery in parallel arrangement so can leave two sides of body to install other electric parts and accessories such as Push on-off switch, motion/moving detectors sensor, IR or RF receiver, Wi-Fi receiver, Bluetooth receiver, photos sensor, IC, adaptor, rechargeable batteries. Power fail or other preferred added functions such as timer, dimmer, magnetic contactor, magnetic conductive-movable-piece or kits or set. mix color, color changing electric parts or accessories or related parts.

From FIG. 5 show the 12 LEDs (04R) install on 12/ 1/ 2/ 3/ 4/ 5/ 6/ 7/ 8/ 9/ 10/ 11/ 12 positions like clock dial face and each one is under the top cover roof (not shown) and all 12 LEDs (04R) is surrounded by the hi-reflective wall (07R) to make all the light beam only can travel within the inner space of the wall (07R) or emit out from the top lens (03R). The PCB (05R) has the high-reflective white surface so any light beam emit into will be reflected to other direction and may through the top lens (03R) and refracted out to viewer. The circuit board (05) in dodecagon shape or can be any shape to fit the top cover and lower base (not shown). From PCB (05R) also can see the quickly connector set (08R) which can connect to AC or-and DC power source, can deliver the electric signal, can link to other PCB, or link circuit, power, light source for more than one or more sets for a system.

From FIG. 5-1 and FIG. 5-3 show all current invention for super slim and no bright-sport LED light optics-design. It can be any LED light device as long as has LEDs install under top cover roof plus has hi-reflective inner surface of top cover or walls plus PCB act as divider to form a top compartment and LED light beam do not leakage out from top compartment is current invention features. The current invention may have all different construction as long as top compartment optic-design as above discussed which can be any LED light for finished products such as punk light or ceiling light, or is a LED-unit to work with main products such as track light.

From FIG. 5-1 see the LED has different color including one color LED (04N1) and multiple color in one LED (04N2) or multiple piece single color (04N3). All these LED can incorporate with IC and circuit to make it has color changing, color freeze, Instant white color illumination, Fade-in and fade-out, auto changing color, mix color, moving color, moving effects, flashing, sequential, chasing or any LED light functions, performances, effects available from market place.

Same as earlier discussion the Total LED light for finish products for Punk light it can be only 24 mm height for desired brightness 20 to 200 lumens depend on the number of LED and battery life needed.

Same as FIG. 5-3 for current super slim design and construction which

Has 28 mm for punk light use which maybe is push on/off switch, IR or RF remote control punk light, motion/moving detector sensor control unit, Wi-Fi or-and APP or wireless control light, or-and blue-tooth connection control light. The FIG. 5-3 has bigger lit-area than the FIG. 5-1 which depend on optics-design.

From FIG. 5-2 is bulk thicker unit. As above discussion.

From FIG. 6-1, FIG. 6-2, FIG. 6-3 show the different application comparison for (A) put 3 pcs LED under the top lens or (B) put 6 LED under top cover roof. The (A) is traditional which as above discussed has many defects. The (B) is current invention has LED under the light block-out top cover+hi-reflective surface inner of the top cover or walls surrounded the 6 LED (not shown)+Plus other functions such as these 3 embodiments has motion sensor on top cover. The preferred as FIG. 8-1, FIG. 8-2, FIG. 8-3, FIG. 8-4 has dome motion sensor on center location for top or high LED light application such as ceiling light or top of door light.

From FIG. 6-4, FIG. 6-5, FIG. 6-6 show the alternative arrangement which has big curved top lens which has preferred current invention and inside to put some big capacity battery such as AA, SC, D, F batteries or rechargeable battery for motion sensor LED light applications. The motion sensor put on side ring or center depend on how the lit-areas for application. This is alternative for the above (B) of current invention. This is examples for any alternative or replaceable or equal functions to get super slim without bright-spots by hi-reflective surface help for top no light leakage compartment should be still fall within the current invention scope and claims.

From FIG. 7 show the above discussed LED light or LED-unit has slim plug hi-reflective surface make multiple reflection or-and refraction for top compartment arrange on the main product. Here the main product is a track light device. FIG. 7 shown the track light (700) has “U-shape” base (701) and “ [symbol] -shape” top cover (703) and top cover has at one pair of magnetic buss-strips (703) (703′) which has magnetic property can attach any material has reaction for the magnetic field such as iron metal or rubber magnetic piece or any material can have reaction with magnetic field. The pair of magnetic buss-strip (703) (703′) to fit within the top cover (702) pair of groove so can make it flat for better touch feeling. The two magnetic buss-strip (703) (703′) each has two end to pass through the two opening of top cover (702) and under the two end caps (704) (704′) to connect with below PCB (not shown) to get electric power or signal. The track light (700)

“ [symbol] -shape” top cover (703) inner surface top location install a PCB (not shown) and PCB lower surface has built-in battery installation terminal so no need to make the battery installation terminal on “U-shape” base (701) to make more soldering work and more wires more trouble. However, to arrange battery terminals on the “U-shape” base (701) still fall within current invention scope. The other circuit or IC all install on the PCB (not shown) to offer the electric signal to turn on-off the LED light for all kind of pre-determined functions, effects, moving effects, color changing, dimmer, color mixed, chasing, sequential, timer, duty cycles, duration . . . etc.

The said several LED-unit (705A) (705B) (705C) has magnetic contactor or magnetic conductive-movable-contactors on back which both has magnetic reaction for pair of magnetic buss-strip (702) magnetic-field. So easily to attach or detachable or add or remove the said LED-unit from the said top cover (702).

From FIG. 7-1 show the top cover (702A) has pair of magnetic buss-strips (703A) (703A′) which has magnetic field so can attach the LED-unit (705D) (705E) (705F) by reaction of the said LED-unit back magnetic contactors or magnetic conductive-movable-contactors. The buss-strip (703A) (703A′) preferred has around 5 mm width to fit within the groove which may around 6 mm width and two end of buss-strips bend into 90 degree so can passing through the openings (not shown) under the end-cap (704A) (704A′) to connect with below PCB (not shown).

From FIG. 7-2 shown the base (701A) which can be one piece “U-shape” base (701) has two ends has door or covers to install or replace batteries. The battery (706-1) (706-2) (706-3) preferred is AA battery and put in parallel side by side around 5.2 mm (2 inch) that is perfect size for the track light width. The “U-shape” base is one piece or has alternative design which use more than one piece “battery-compartment” to form in same length of the base and each “battery-compartment” can has its own three piece AA battery inside with link-kits to link with other battery-compartments. The each “battery-compartment” also can change positions while needed, so this arrangement supply at least one of backup “battery compartment”. Same as the said track light it also can have alternative design to add link-kit so can link one track light to others track light to link to design length or-and turn angle to “L” or “Y” or other geometric shape.

From FIG. 7-3 show the “battery compartment” (701G) is install and designed on the one end of track light unit. This shown other alternative embodiment.

From FIG. 7-4 show the preferred track light has four current inventions slim and none bright-spots LED-unit (705J) which magnetic conductive-movable-contactors (not shown) on back so not only can attach to top cover (702C) magnetic buss-strips (703C) (703C′) but also can deliver the electric signal to each attached LED-unit (705J). The said LED-unit (705J) has base (01W) and top cover (02W). The all LEDs of LED-unit (705J) are install under the top cover (02W) roof so LEDs cannot see from top lens (03W) and PCB (05W) is under the LEDs and other features as above discussed.

From FIG. 7-A, FIG. 7-B, FIG. 7-C, FIG. 7-D show the said LED-unit (705K) (705L) (705M) (705N) each has slim and non-bright-spots optics design as above discussed. Those also has different trigger to turn on-off LEDs which the said FIG. 7-A incorporate the push on-off switch which located under the top lens and whole top lens edge is connect with spring and switch bar whenever push the top lens can turn on or turn off the LEDs. It also can have upgrade model to have time delay or auto timer which when people forget to push top lens to turn off, the light will automatically to turn off after preset time period such as 5/10/15/20/25/30 minutes.

From the FIG. 7-B LED-units as above has back contractor incorporate with motion or moving detectors sensor or-and photo sensor. While motion or moving been detected by sensor or sensor-assembly the LED-unit will turn on with more upgrade model such as time delay, duration or even flashing or what kind of market available functions can also add into the said LED light or LED-unit circuit depend on market required. The motion sensor or moving sensor or photo sensor can install any location depend on for what areas need to be detected or simplest is use dome sensor can cover 360 degrees but it has defect for shorter distance, the panel type Fresnel lens not dome shape Fresnel has much far distance and also can trigger the two end of panel areas by special optics-design to increase the signal emit into Fresnel. The motion sensor incorporate with photo sensor will make more power saving while under bright environment the LED light or LED-unit(s) will not be triggered and waste battery or AC power energy for brighter environment.

From FIG. 7-C show the LED light or LED-unit has incorporated with IR or RF remote control system. The IR or RF receiver kits can install on LED light here is track light housing to control all LED-units or install on each LED-units to make only each one of LED-units. The IR had direction problem for receiving electric signal. The RF has better because less direction problem for receiving electric signal and also has longer distance but cost little higher. However, the update for wireless system which through Wi-Fi or-and APP or-and server or-and even cloud with 3G/4G/5G network that will make much more functions or selections or adjustment for color, brightness, color mixed, dimmer, timer, instant white, sensitivity, communication, auto changing color, trigger other pre-set functions. Also, while incorporate Wi-Fi and APP it almost is unlimited distance for unlimited functions which depend on what software or APP be programmed.
From FIG. 7-D show the LED-unit has self-powered so the LED-unit move out from the magnetic buss-strip. The LED-unit can use it pre-set manual switch to turn on the LED-unit for pre-program function. While this kind of LED-unit has built-in battery, it also can have USB port to charge the inner built-in rechargeable battery. It also can act as USB power bank through most common type A USB-port to connect with two USB-plug wire set to connect with other electric device to supply the internal rechargeable battery power to other device. These USB relation application is update for people so the LED-units on the track light is no more just a light for limited place but also can remove or move out to use for anywhere plus the power bank functions. While it ran out built-in rechargeable battery energy can use USB wire to charge it anywhere so become a multiple function LED-unit for track light, for refrigerator or metal surface use, for car repair use, for car accident use as warning light, for camping use, for outdoor activity, for emergency power back to charge phone . . . etc.
   This is other update application for USB related to be charged or supply current to other device as power bank through USB-port built-in LED light device. The current slim and non-bright-spot LED light or LED-unit of current invention scope. It is appreciated all these discussion and co-pending for LED light as Co-pending filing case has USB port built-in LED light device including Bulb, Garden light, light string, night light as US (#QQQ-6) U.S. application Ser. No. 15,355,515 filed on Nov. 18, 2016. which is Continue filing for (#QQQ-5) U.S. application Ser. No. 15,341,782 filed on Nov. 2, 2016. which is Continue filing for (#QQQ-4) US application Ser. No. 15,348,218 filed on Nov. 10, 2016. which is the Continue filing for (# QQQ-3) U.S. application Ser. No. 14,983,993 filed on Dec. 30, 2015. which is the Continue filing for (#QQQ-2) U.S. application Ser. No. 14,289,968 filed on May 29, 2014 now is U.S. Pat. No. 9,551,477. Which is Division filing of (# QQQ-1) of U.S. application Ser. No. 14,280,865, filed on May 19, 2014 now is U.S. Pat. No. 9,581,229, and is Continuously of (#QQQ-12) U.S. Ser. No. 13,540,728 LED Bulb now is U.S. Pat. No. 8,834,009. Related for LED bulb has project or-and night light. Which shown USB ports or USB adaptor concept on issued patent 1^{st} page is CIP Filing of U.S. application Number Ser. No. 13,296,508 Filed on Nov. 15, 2011 Now is U.S. Pat. No. 8,562,158. Which is CIP Filing of U.S. application Ser. No. 13,296,469 Filed on Nov. 15, 2011 now is U.S. Pat. No. 8,711,216.
      The USB ports and Adaptor apply for LED light device including bulb or night light shown on co-pending filing is Division filing of (#MMM-2) U.S. application Ser. No. 15,402,965 filed on Jan. 10, 2017. which is the Continue filing for (# MMM-1) U.S. application Ser. No. 14,606,242 filed on Jan. 27, 2015 now is U.S. Pat. No. 9,541,260. which is Continue in Part of (# MMM-11) U.S. application Ser. No. 13,367,758 filed on Feb. 7, 2012, Now is U.S. Pat. No. 8,967,831. Which is related for the LED Bulb has extendable/retractable design to overcome block-items that may interfering the camera, electric signal delivery. And also (LED or-and laser) bulb has the USB ports and Rechargeable batteries and rechargeable circuit to be charged or supply current to other device so including USB Charger, Power bank, (LED or-and Laser) light device's functions has at least 3 functions in one unit.

From FIG. 7-6 show the magnetic contactor or magnetic conductive-movable-contactor on back of LED-unit (705P) (705q) (705R) for different distance with magnetic field from magnetic buss-strips (703X) which inside groove of the top cover (702E).

While the (705p) is far away the magnetic file, the contactor will fall-down to opening.

While the (705q) is just touch the magnetic field, the contactor will little pop-up.

While the (705R) is fall almost touch the magnetic field, the contractor will totally pop-up to attach on the magnetic buss-strips and build up electric delivery.

From FIG. 8-1, FIG. 8-2, FIG. 8-3, FIG. 8-4 show all preferred current invention for slim and non-bright-spots LED light for Big size 6 to 15-inch diameter for ceiling light which has optional motion sensor install on the center and all LEDs install under the cover light block-out material so no LED can be seen from light output lens. While it became small size 1 to 5-inch diameter can become closet or under-cabinet light or living room punk light. While it more compact size can incorporate with main products such as become track light movable, attachable, detachable LED-unit.

From FIG. 9, See the total 5 levels. Each level can have tall wall or not depend on design requirement.

From FIG. 9 is desk top application or other camping application by battery which can offer great illumination and wider to cover not only 180 of front but also cover the sides illumination up to 270 degrees for whole angle.

From FIG. 9b and FIG. 9c and FIG. 9d, show the illumination for top ceiling installation. Same the features are not only the front 180-degree flat top-lens can emit light but also the sides can also emit light so can get 180 degrees flat+two side each may up to 45 to 60 degree=so total can add 90 to 120-degree top of the 180 degrees=300 degrees or other alternative design for angles. So it an offer walking closet or front door or garage or patio or garden for top installation ceiling light has 4 to 20-inch diameter or other geometric shape lit-areas with one or more than one levels/steps for in-directly LED light beam.

From FIG. 9b, show the increase each level or steps height so can make variety of design.

FIG. 9-1 show the alternative and same as above has in-direct LED light beam to the top lens but not under cover, housing, roof of housing or parts. The SMD LEDs is install on flexible PCB or substrate so can bendable into circuit shape install on the housing groove to emit the light inward or outward depend on where need to light. It also has the hi-reflective surface or walls or top cover to make multiple times reflection within the top compartment which has no light beam leakage out.

FIG. 9-2 show the same as the FIG. 1 to FIG. 6 all related drawing which PCB is hard piece and has top cover, roof, housing, parts to prevent light beam direct to see from top lens. However, for Big lit-areas to has even and super strong light brightness and even photometric, this is not workable so this treatment only can apply for the LED light lit-area less than 4-inch diameter or same square lit-areas for geometric shape for lit-area. Bigger than 4 inch diameter up to 20 inch for lit-area only can use the FIG. 9-1 or following FIG. 9 for LED-assembly or more than one of LED assembly to get big lit-areas or multiple level lit-areas or top/side illumination purpose. The hard PCB and SMD face up is too costly to make big areas illumination because bigger size PCB is more expensive. Especially the current requirement for all LEDs under cover, housing, parts to get the in-direct light beam show on the top lens so it is too costly for SMD LEDs all face up on hard PCB.

From FIG. 9-3a and FIG. 9-3b, show the 5 level or steps top-lens has not only front illumination and also has good brightness emit from side so increase the illumination for more areas and not only front side of LED light. The FIG. 9-3a which is shallow disk like top lens, not same as FIG. 9-3b which each level or step has high wall so more look like 5 steps.

From FIG. 9-3c and FIG. 9-3d show other application for motion or moving detector(s) sensor ceiling light has 3 to 20-inch diameter for round or any geometric shape. Also the added functions or features is all same as co-inventor's earlier or pending filed case including it and all related parent filed case such as (# KKK) U.S. application Ser. No. 13,296, 508 filed on Nov. 15, 2011 and (# MMM-2) U.S. application Ser. No. 15,402,965 filed on Feb. 22, 2012.

From FIG. 9-4A and FIG. 9-4b show the same as FIG. 9-3a and FIG. 9-3b. but different at 9-4a is motion sensor and FIG. 9-4a is moving detector(s) sensor.

From FIG. 9-4c and FIG. 9-4d same as above FIG. 9-3c and FIG. 9-3d. Also the added functions or features is all same as co-inventor's earlier or pending filed case including it and all related parent filed case such as (# KKK) U.S. application Ser. No. 13,296, 508 filed on Nov. 15, 2011 and (# MMM-2) U.S. application Ser. No. 15,402,965 filed on Feb. 22, 2012. show all other features or functions can add into the current big lit-area application such as ceiling light or wall mounted light of battery or wired or plug-in LED light.

I claim:

1. ADC powered LED light device optics arrangement comprising:
At one LED as light source to offer in-direct brightness.
At least one high reflective housing or wall to offer light beam for multiple times reflected or-and refracted and emit out from top lens lit-area(s).
LED install on hard or bendable circuit board that has PCB or housing divider to form a compartment which only has LED(s), high reflective or-and refractive housing or parts, PCB, lens.
The said top compartment is to prevent from light beam leakage-out and majority of light beam emit out from top lens.

2. A DC powered LED light device optics arrangement as claiml, the said high reflective surface is a housing or wall or parts which make LED light beams has multiple times reflected or-and refraction before emit out from the top-lens.

3. ADC powered LED light device optics arrangement as claim 1, the said light beam emit out from lens after multiple times reflected or-and go through lens refractive properties so offer wider and strong light beam.

4. A DC powered LED light device optics arrangement as claim 1, the said LED is install under the light-block material housing, cover, ring, roof and not under the lens lit-area to offer the in-direct LED light beam to viewer.

5. A DC powered LED light device optics arrangement as claim 1, the said LED is white or red or green or blue or multiple colors (SMD) surface mounted type or Dip type.

6. A DC powered LED light device optics arrangement as claim 1, the said LED is turn on or turn off by switch, motion or moving detector(s) sensor, remote controller, wireless system, integrated circuit (IC) for steady or moving or color changing effects or automatic changing & freeze color function, performance, light show.

7. ADC powered LED light device optics arrangement as claim 1, the said light beam only travel within the said compartment and emit out from lens.

8. A DC powered LED light device optics arrangement as claim 1, the said high-reflective surface or housing or parts is at least one of (1) high polished plastic, or (2) mirror-like metalized plastic, or (3) shinning metal piece and (4) white upper-side circuit board.

9. A DC powered LED light device optics arrangement as claim 1, the said circuit board as divider has lower-side is face down and has electric parts and accessories to connect LED(s) with DC power source select from battery or rechargeable battery or device has USB-ports to offer DC power.

10. A DC powered LED light device optics arrangement as claim 1, the said high reflective wall is surrounding all LEDs inside the wall so all light will not leakage out from wall and light beam reflected by wall back to inner lens so all light beam only can travel within the inside of wall.

11. ADC powered LED light device optics arrangement claim 1, the said high reflective housing or parts or compartment surface(s) which offer desired angle to let light beam emit into and reflected or refracted and emit out from the lens.

12. A DC powered LED light device optics arrangement as claim 1, the said thin LED light made by install SMD LEDs for super slim thickness on circuit board (PCB) which is a divider and lower-side has install battery-contactor(s) so battery can install on lower-side surface to save other plastic added divider which min. 1 mm or more.

13. A DC powered LED light device optics arrangement as claim 1, the said LED(s) functions for steady or moving effects including but not limited select from chasing, random, fade-in & fade-out, pair flashing, color changing, auto color changing or-and freeze color, instant white, dimmable, brightness control, timer for turn on for period of time, by controller or selector through wired or wireless system or transmission.

14. A DC powered LED light device optics arrangement as claim 1, the said LED(s) control by wireless including blue-tooth connection, IR or RF remote controller, or wireless controller through APP software through the 3G/4G/5G network or Wi-Fi or-and servers, cloud storage stations.

15. ADC powered LED light device optics arrangement as claim 1, the said LED light has attachment kits to install on closet, under cabinet, bar, kitchen, ceiling, door, garden, patio, backyard, garage or desired locations by screw, phone holes, double side tape, 3M tape, Velcro tape, glue, magnetic, conductive and movable magnetic piece to desired material including wood, metal surface.

16. ADC powered LED light device optics arrangement as claim 1, the said DC power get from USB-port(s) and USB-wire set from DC power bank of DC electric device has DC current output.

17. ADC powered LED light device optics arrangement as claim 1, the said DC power including the LED light device has AC input-adaptor(s) to get AC power and go through LED light built-in AC-to-DC circuit.

18. ADC powered LED light device optics arrangement as claim 1, the said DC power including the LED light has a female adaptor to receiving male plugs come out from outside AC-to-DC transformer, inverter.

19. A DC powered LED light device optics arrangement as claim 1, the said LED is SMD LED(s) install on the flexible or bendable or soft PCB to allow the bend in geometric shape or circle to allow the SMD LEDs light beam emit inward or-and outward to offer in-direct LED light beam to travel within the compartment.

20. A DC powered LED light device optics arrangement as claim 19, the said flexible or bendable or soft PCB install under the motion/moving detector sensor or fit within the compartment plastic wall or compartment grooves by attachment kits.

21. A DC powered LED light device optics arrangement as claim 19, the said flexible or bendable or soft PCB can fit on a pole or bar to offer many levels to offer the different levels or step of lit-area of the said top lens.

22. ADC powered LED light device optics arrangement as claim 1, the said LED light has disc-shallow shape or multiple levels or steps sphere top cover with or without the sides illumination arrangement.

23. A DC powered LED light device optics arrangement as claim 1, the said multiple levers or steps LED light top cover has other geometric shape to offer front or-and sides illumination powered by DC or-and AC wired or-and DC transformer.

24. ADC powered LED light device optics arrangement as claim 1, the said super slim LED light for less than 4-inch diameter or equal lit-areas by flexible or bendable PCB can reduce one of hard PCB thickness so can become super slim and it also will offer whole top lens has even brightness by in-direct LED light beam through multiple times reflected or-and refracted.

25. A DC power LED light device optics arrangement as claim 1, the said flexible or bendable PCB has SMD LEDs can have as many as sets so can make sufficient and even brightness for multiple levels or steps LED light or super big size lit-area which from four to twenty-inch diameter lit-area has desired perfect illumination on front or-and sides.

26. ADC powered LED light device optics arrangement as claim 1, the said LED light has conductive and movable magnetic kits which can attached on any metal can reactivated with magnetic force for quickly install and delivery the electric current through the conductive and movable magnetic kits.

27. A LED light, comprising:
at least one track assembly has plurality of magnetic bus-strips to adhesive or install at least one LED-unit which has pop-out or fall-down metal magnetic conductive-movable-contact(s) on back and the LED-unit(s) install or remove from anywhere along length by magnetic interaction force.
at least one LED-unit including at least one LED, said LED having predetermined brightness, color, illumination direction, viewing angle, electric signal receiver, IR/RF receiver for offer illumination to area(s);
the LED-unit including conductive piece which can pop-out or fall-down from back housing openings of LED-unit while metal contactor(s) near the bus-strips magnetic force and it will pop-out and adhesive on the buss-strips for electrically delivery from bus-strips to LED-unit to cause the at least one LED light source(s) to turn on-off under predetermined functions, performance, and duration; and
the LED-unit having a geometric shape, size, cover, housing, insulation, opening on back for movable magnetic-contactor(s), pop-out or fall-down movable construction, and holding parts that allow a person to move, change position, add, remove, assemble, or disassemble the LED-unit; and
the LED-units at least has two contactors.
The light device that can use LED-unit back side pop-out and fall-down function incorporate with magnetic bus-strips anywhere along the track length by magnetic force to install LED-unit(s) anywhere for adding or move-out LED-unit(s).
The improvement for LED-units which has at least one or more function selected from (1) has push on-off switch, or (2) has motion or moving detector(s) sensor, or (3) has IR or RF remote control system, or (4)
has built-in power source including backup batteries or rechargeable battery.

28. A LED light as claim 27, wherein said pop-out and fall-down metal contactor(s) on the back side of LED-unit to adhesive to the bus-strips has strong magnetic force without polarization poles so contactor(s) can touch any one of pair buss-strip to build the electric power delivery.

29. A LED light as claim 27, wherein said conductive contacts on the back of LED-unit at least one pair or plurality pairs to make color changing for any combination for Red, Green, Blue and White LED(s).

30. A LED light as claim 27, wherein said the magnetic bus-strip on the track at least one pair or plurality of pairs to make contact with LED-unit(s) which has more than one LED light source within.

31. A LED light as claim 27, the said and pop-out and fall-down contactors has no polarized difference design so any way to make 2 contactors connect to any way will not cause the inside LED(s) source to damage or electric shortage.

32. A LED light as claim 27, the said LED-unit(s) has IC and circuit to make the LED-unit to have white, one, multiple, changing, auto changing and freeze color function with preferred steady or moving light or jumping light functions from the circuitry or-and IC.

33. A LED light as claim 27, the said power by DC source which has desired compartment under the buss-strips for battery powered application which can have AAA or AA or SC or DD or F battery or rechargeable batteries.

34. A LED light as claim 27, the said power from AC source through the said (1) built-in AC-to-DC circuitry or (2) through the device's adaptor hole or receiving hole to connect with external housing AC-to-DC transformer to get power for light device inner conductive-parts or DC-to-DC circuit to supply related electric parts & accessories which may had different more than one working DC voltage to have desired function, performance, and light illumination.

35. A LED light as claim 27, the said the said LED-unit turn-on and turn-off by (A) push on-off switch built-on LED-unit(s), or (B) by motion or moving detector(s) sensor built-in LED-light, or (C) by IR or RF remote-control system which has outside transmitter and built-in receiver on each of LED-unit to turn on only one LED-unit, or receiver built-in light device for all LED-unit(s), or (D) by Wi-Fi or-and wireless communication and APP software to operate the said one or all LED-unit(s) optional incorporate with server or cloud storage station and 3G/4G/5G or more update networks.
